(19) United States
(12) Patent Application Publication
(10) Pub. No.: US 2007/0287337 A1
(43) Pub. Date: Dec. 13, 2007

(54) PLUG CONNECTOR

(75) Inventors: Josef Bauer, Walting (DE); Hans-Hermann Gmeiner, Ingolstadt (DE); Georg Lechermann, Penzberg (DE); Catrin Tempelhoff, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/761,448

(22) Filed: Jun. 12, 2007

(30) Foreign Application Priority Data
Jun. 12, 2006 (DE) 10 2006 027 183.1

(51) Int. Cl. H01R 13/15

(52) U.S. Cl. 439/839

(57) ABSTRACT

A plug connector for supplying power to an electrical load, in particular a lamp, includes a contact spring for electrical connection to a contact blade, a contact blade for electrical connection to a contact spring, and includes a conductor connection for connection of a connection line, wherein the contact spring and the contact blade have a substantially identical insertion direction.

### TECHNICAL FIELD

The invention relates to a plug connector for supplying power to an electrical load, in particular a lamp, comprising a contact spring for electrical connection to a contact blade, a contact blade for electrical connection to a contact spring, and comprising a conductor connection for connection of a connection line.

### BACKGROUND ART

A plug connector of this type is described, for example, on the Internet site www.elpress.de under the product name “multiple tabs”. These conventional plug connectors are provided with a contact spring (flat plug sleeve) for electrical connection to a contact blade (flat connector) and a contact blade, which runs at an angle to the insertion direction of the contact blade, for electrical connection to a contact spring of a power supply line. A conductor connection which is in the form of a pinched connection (crimp connection) is provided for connection of a connection line. One disadvantage of plug connectors of this type is that the power supply line, which is connected to a contact spring, for making contact with the contact blade of the plug connector has to be bent and led back to said contact blade, with the result that a large installation space is required and assembly of the plug connector is complex.

### DISCLOSURE OF THE INVENTION

The invention is based on the object of providing a plug connector which, compared to conventional solutions, permits simplified cable routing together with a reduced space requirement.

This object is achieved by a plug connector for supplying power to an electrical load, in particular a lamp, comprising a contact spring for electrical connection to a contact blade, a contact blade for electrical connection to a contact spring, and comprising a conductor connection for connection of a connection line, wherein the contact spring and the contact blade have a substantially identical insertion direction.

As compared to the prior art, the plug connector according to the invention permits substantially simplified cable routing of the power supply line together with a reduced space requirement since said plug connector does not have to be bent and led back on account of the identical insertion direction for making contact with the plug connector.

According to one particularly preferred exemplary embodiment, the contact spring and the contact blade run approximately parallel to one another and are formed opposite the conductor connection. The result achieved is an extremely compact design of the plug connector.

The contact spring preferably has two spring tabs which are situated opposite one another and which form an accommodation region, in which the contact blade of the power supply line can be clamped, with a rear wall of the contact spring.

In a particularly preferred embodiment of the invention, the spring tabs are bent inward in such a way that edge sections of the spring tabs run approximately perpendicular to the rear wall of the accommodation region.

According to an inventive variant of the plug connector, the edge sections of the spring tabs are bent toward one another and, at least in sections, run approximately parallel to the rear wall of the accommodation region.

In both variants, the spring tabs can be arranged on that side of the contact spring which faces the contact blade or that side of the contact spring which is averted from the contact blade.

At least sections of the spring tabs are preferably of curved design, in order to achieve a high clamping force compared to the contact blade of the power supply line, together with a low material requirement.

According to a preferred exemplary embodiment of the invention, the contact spring and the contact blade have a common connecting section. This connecting section can form a stop face for limiting the insertion depth of the contact spring and/or of the contact blade in the plug connector.

The contact blade is preferably embodied in an approximately plate-like manner with a substantially rectangular base area.

It has proven particularly advantageous for the connection line to be connected to the conductor connection by means of a crimped, welded and/or soldered connection.

The conductor connection preferably has at least one wire claw for making electrical contact with stripped ends of the connection line.

In a further development of the invention, the conductor connection has at least one insulation-displacement contact (IDC) for making contact with the connection line.

According to one exemplary embodiment of the invention, the conductor connection is provided with at least one insulation claw which surrounds at least a circumferential section of the insulation sheath of the connection line in order to relieve the strain on the connection line.

The contact blade, the contact spring and the conductor connection are preferably of integral design for production reasons. A plug connector of this type can advantageously be produced as a stamped and bent sheet-metal part, for example.

The plug connector according to the invention is preferably used in a lamp having a cable connection, in particular a lamp for airfield illumination.

### BRIEF DESCRIPTION OF THE DRAWINGS

The invention is explained in greater detail below with reference to preferred exemplary embodiments. In the drawings:

FIG. 1 shows a schematic illustration of a plug connector in accordance with a first exemplary embodiment according to the invention;

FIG. 2 shows a schematic illustration of a plug connector in accordance with a second exemplary embodiment according to the invention, and

FIG. 3 shows a schematic illustration of an angled sheet-metal portion of the plug connector from FIG. 2.

### BEST MODE FOR CARRYING OUT THE INVENTIONS

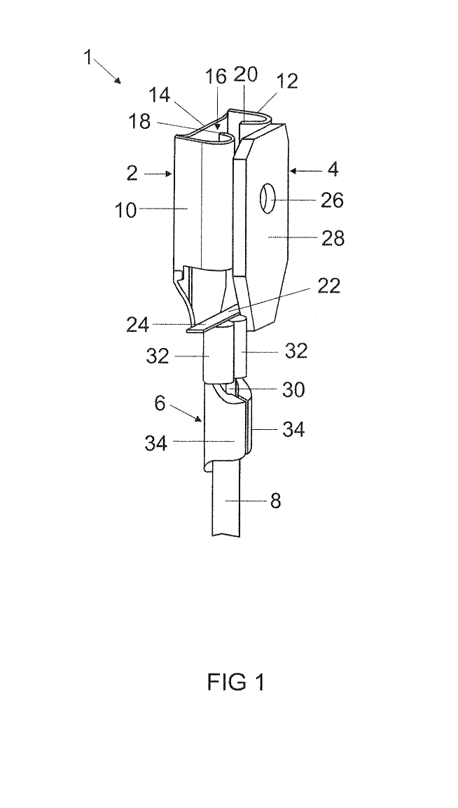

FIG. 1 shows a schematic illustration of a plug connector 1 according to the invention for supplying power to an electrical load (not illustrated), for example a lamp for airfield illumination. The plug connector 1 has a contact spring 2 for optionally accommodating a contact blade (not illustrated) of a power supply line of the load and has a contact blade 4 for electrical connection to a contact spring (not illustrated) of a power supply line of the load. The plug connector 1 also has a conductor connection 6 for connection of a connection line 8. According to the invention, the contact spring 2 and the contact blade 4 have a substantially identical insertion direction. As a result, the plug connector 1 permits simple cable routing together with a reduced space requirement since the connection line 8 of the plug connector 1 or the power supply line of the lamp (not illustrated) for making contact with the plug connector 1 does not have to be bent and led back. In the illustrated exemplary embodiment, the contact spring 2 and the contact blade 4 run approximately parallel to one another and are formed opposite the conductor connection 6. The contact spring 2 has two spring tabs 10, 12 which are opposite one another and form an accommodation region 16, in which the contact blade (not illustrated) of the power supply line can be clamped, with a rear wall 14 of the contact spring 2. The spring tabs 10, 12 are bent inward in such a way that edge sections 18, 20 run approximately perpendicular to the rear wall 14 of the accommodation region 16. To this end, sections of the spring tabs 10, 12 are of curved design. The spring tabs 10, 12 are arranged on that side of the contact spring 2 which faces the contact blade 4, with the result that an extremely compact design of the plug connector 1 is achieved. To improve the clamping action, bearing projections (not illustrated) for the contact blade of the power supply line are provided on the rear wall 14. The contact spring 2 and the contact blade 4 have a common connecting section 22 which forms a stop face 24 for limiting the insertion depth of the contact spring and/or of the contact blade of the power supply line. The contact blade 4 is provided with an eyelet 26 approximately in the center and is of plate-like design with a rectangular base area 28 with chamfered corner regions. In order to make electrical contact with a stripped end 30 of the connection line 8, the conductor connection 6 is formed as a pinched connection (crimped connection) with two wire claws 32 which are opposite one another and are pinch-connected to the end 30 of the connection line 8. In order to relieve the strain on the connection line 8, the conductor connection 6 is provided with two insulation claws 34 which surround a circumferential section of the insulation sheath of the connection line 8 and are pressed against said connection line. The contact blade 4, the contact spring 2 and the conductor connection 6 are preferably of integral design for production reasons. A plug connector 1 of this type can advantageously be produced as a stamped and bent sheet-metal part, for example.

In one exemplary embodiment (not illustrated), the connection line 8 is connected to the plug connector 1 by means of an insulation-displacement contact.

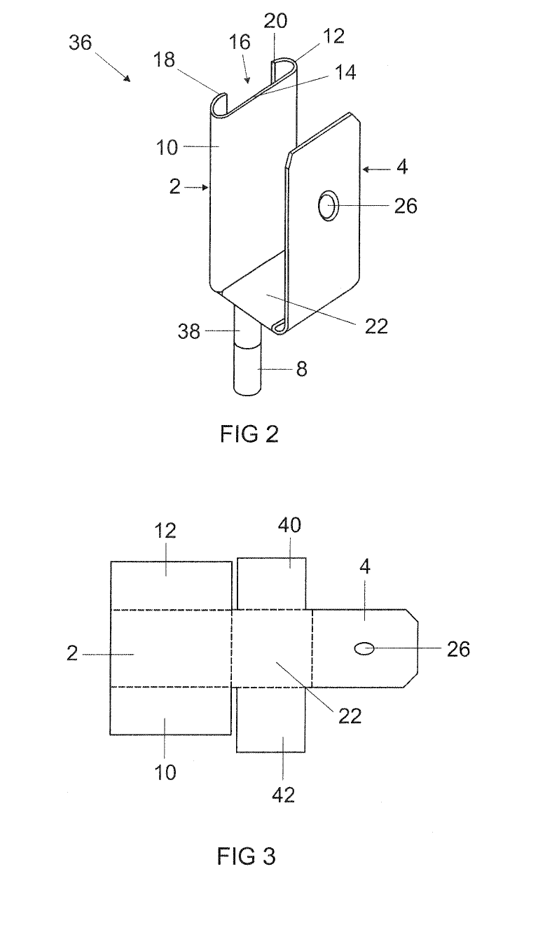

According to FIG. 2, which shows a plug connector 36 in accordance with a second exemplary embodiment according to the invention, the edge sections 18, 20 of the spring tabs 10, 12 are bent toward one another in a curved manner and run approximately parallel to the rear wall 14 of the accommodation region 16 in this exemplary embodiment. Furthermore, in comparison to the above-described exemplary embodiment, the spring tabs 10, 12 are arranged on that side of the contact spring 2 which is averted from the contact blade 4 in this variant. In order to make electrical contact with the connection line 8, a conductor connection 6, which is in the form of a connecting sleeve 38, is provided on the rear face of the common connecting section 22 of the contact spring 2 and of the contact blade 4. The connecting sleeve 38 may be in the form of a pinched connection or a welding or soldering sleeve for accommodating the connection line 8.

As can be seen particularly in FIG. 3, which shows a plan view of an angled sheet-metal portion of the plug connector 36 from FIG. 2, the contact spring 2 and the contact blade 4 are connected via the common connecting section 22. Two opposite free edge sections of said connecting section are provided with tabs 40, 42 for forming the connecting sleeve 38 (see FIG. 2).

The plug connector 1, 36 according to the invention is not restricted to the illustrated embodiment of the contact spring 2 and the contact blade 4, but instead the plug connector 1, 36 can be provided with various contact spring and contact blade forms which are known from the prior art.

This document discloses a plug connector 1, 36 for supplying power to an electrical load, in particular a lamp, comprising a contact spring 2 for electrical connection to a contact blade, a contact blade 4 for electrical connection to a contact spring, and comprising a conductor connection 6 for connection of a connection line 8, wherein the contact spring 2 and the contact blade 4 have a substantially identical insertion direction.

### LIST OF REFERENCE SYMBOLS

1 Plug connector
2 Contact spring
4 Contact blade
6 Conductor connection
8 Connection line
10 Spring tab
12 Spring tab
14 Rear wall
16 Accommodation region
18 Edge section
20 Edge section
22 Connecting section
24 Stop face
26 Eyelet
28 Base area
30 Line end
32 Wire claw
34 Insulation claw
36 Plug connector
38 Connecting sleeve
40 Tab
42 Tab

1. A plug connector for supplying power to an electrical load, in particular a lamp, comprising a contact spring for electrical connection to a contact blade, a contact blade for electrical connection to a contact spring, and comprising a conductor connection for connection of a connection line, whereby the contact spring and the contact blade have a substantially identical insertion direction.

2. The plug connector as claimed in claim 1, wherein the contact spring and the contact blade run approximately parallel to one another and are formed opposite the conductor connection.

3. The plug connector as claimed in claim 1, wherein the contact spring has two spring tabs which are situated opposite one another and which form an accommodation region, in which the contact blade can be clamped, with a rear wall of the contact spring.

4. The plug connector as claimed in claim 3, wherein the spring tabs are bent inward in such a way that edge sections of the spring tabs run approximately perpendicular to the rear wall of the accommodation region

5. The plug connector as claimed in claim 3, wherein edge sections of the spring tabs are bent toward one another and, at least in sections, run approximately parallel to the rear wall of the accommodation region.

6. The plug connector as claimed in claim 3, wherein the spring tabs are arranged on that side of the contact spring which faces or is averted from the contact blade.

7. The plug connector as claimed in claim 3, wherein at least sections of the spring tabs are of curved design.

8. The plug connector as claimed in claim 1, wherein the contact spring and the contact blade have a common connecting section.

9. The plug connector as claimed in claim 1, wherein the contact blade is of approximately plate-like design and has a substantially rectangular base area.

10. The plug connector as claimed in claim 1, wherein the connection line is connected to the conductor connection by means of a crimped, welded and/or soldered connection.

11. The plug connector as claimed in claim 10, wherein the conductor connection has at least one wire claw for making electrical contact with a stripped end of the connection line.

12. The plug connector as claimed in claim 10, wherein the conductor connection has at least one insulation-displacement contact (IDC).

13. The plug connector as claimed in claim 1, wherein the conductor connection has at least one insulation claw which surrounds a circumferential section of the insulation sheath of the connection line.

14. The plug connector as claimed in claim 1, wherein the contact blade, the contact spring and the conductor connection are of integral design.

15. The plug connector as claimed in claim 1, wherein said plug connector is embodied as a stamped and bent sheet-metal part.

16. The plug connector as claimed in claim 1, wherein said plug connector is associated with a lamp having a cable connection, in particular a lamp for airfield illumination.

17. The plug connector as claimed in claim 2, wherein the contact spring has two spring tabs which are situated opposite one another and which form an accommodation region, in which the contact blade can be clamped, with a rear wall of the contact spring.
